(19) United States
(12) Patent Application Publication
(10) Pub. No.: US 2013/0078366 A1
(43) Pub. Date: Mar. 28, 2013

(54) METHOD OF MANUFACTURING SOLID ELECTROLYTIC CAPACITOR

(71) Applicant: Yousuke Abe, Sanda-shi (JP)

(72) Inventor: Yousuke Abe, Sanda-shi (JP)

(73) Assignee: SANYO ELECTRIC CO., LTD., Osaka (JP)

(21) Appl. No.: 13/609,965

(22) Filed: Sep. 11, 2012

(30) Foreign Application Priority Data
Sep. 27, 2011 (JP) 2011-210960

(51) Int. Cl. H01G 9/15

(52) U.S. Cl. 427/80

(57) ABSTRACT

A method of manufacturing a solid electrolytic capacitor includes in this order, the steps of forming a dielectric film on a surface of an anode element formed of a porous body, forming a bonding layer containing a silane compound on the dielectric film, and forming a solid electrolytic layer on the dielectric film. The step of forming a bonding layer includes at least any one step of the step of immersing the anode element in a solution containing a silane coupling agent and vibrating at least any one of the anode element and the solution and the step of immersing the anode element in the solution and heating the solution.

This nonprovisional application is based on Japanese Patent Application No. 2011-210960 filed with the Japan Patent Office on Sep. 27, 2011, the entire contents of which are hereby incorporated by reference.

### BACKGROUND OF THE INVENTION

1. Field of the Invention

The present invention relates to a method of manufacturing a solid electrolytic capacitor and particularly to a method of manufacturing a highly reliable solid electrolytic capacitor with the use of a silane coupling agent.

2. Description of the Related Art

In order to achieve reduction in size and increase in capacity of a capacitor, various capacitors have conventionally been developed. Among others, a solid electrolytic capacitor has widely been known as a capacitor suitable for reduction in size. A solid electrolytic capacitor includes an anode element, a dielectric film provided on the anode element, and a solid electrolytic layer provided on the dielectric film, and it has such excellent performance as a large capacity in spite of its small size.

A manganese oxide, a conductive polymer, or the like has widely been used as an electrolyte forming a solid electrolytic layer. A valve metal such as tantalum, niobium, aluminum, or titanium has widely been used as a material for an anode element. By employing a valve metal as a material for an anode element, a dielectric film composed of a metal oxide can uniformly be formed on a surface on the anode element through chemical conversion treatment.

In a solid electrolytic capacitor described above, as the solid electrolytic capacitor is used for a longer period of time, adhesion between a solid electrolytic layer and a dielectric film tends to lower and hence lowering in characteristics such as lowering in capacitance has become a problem. As a technique for solving this problem, for example, Japanese Patent Laying-Open No. 2006-140443 discloses a technique for improving adhesion between a dielectric film and a solid electrolytic layer composed of a conductive polymer by interposing a layer treated with a silane coupling agent between the dielectric film and the solid electrolytic layer.

### SUMMARY OF THE INVENTION

The present inventor, however, has found through various studies that, even with the technique above, adhesion cannot sufficiently be improved in some cases. Therefore, further technical development has been demanded.

In view of the circumstances above, it is an object of the present invention to provide a solid electrolytic capacitor manufacturing method for manufacturing a highly reliable solid electrolytic capacitor with the use of a silane coupling agent.

The present invention is directed to a method of manufacturing a solid electrolytic capacitor, including in this order, the steps of forming a dielectric film on a surface of an anode element formed of a porous body, forming a bonding layer containing a silane compound on the dielectric film, and forming a solid electrolytic layer on the dielectric film, the step of forming a bonding layer including at least any one step of the step of immersing the anode element in a solution containing a silane coupling agent and vibrating at least any one of the anode element and the solution and the step of immersing the anode element in the solution and heating the solution.

According to the present invention, a highly reliable solid electrolytic capacitor can be manufactured.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross-sectional view schematically showing one example of a solid electrolytic capacitor manufactured in one embodiment of the present invention.

FIG. 2 is a flowchart showing one example of a method of manufacturing the solid electrolytic capacitor in FIG. 1.

FIGS. 3(A) to 3(E) are cross-sectional views schematically showing a process for manufacturing the solid electrolytic capacitor in FIG. 1.

FIG. 4 is a schematic enlarged view of a region A in FIG. 3(B).

FIG. 5 is a schematic cross-sectional view showing one example of the step of vibrating an anode element.

FIG. 6 is a schematic cross-sectional view showing one example of the step of vibrating a solution.

FIG. 7 is a schematic cross-sectional view showing one example of the step of heating the solution.

### DESCRIPTION OF THE PREFERRED EMBODIMENTS

In order to realize a solid electrolytic capacitor having high reliability and large capacitance, the present inventor has studied formation of an anode element with the use of valve metal particles smaller in size than those in a conventional example and further formation of a bonding layer containing a silane compound between a dielectric film and a solid electrolytic layer. The studies have been conducted in the expectation that, by forming an anode element by sintering valve metal particles small in size, a surface area of the anode element increases and capacitance of a solid electrolytic capacitor increases and by forming a bonding layer, peeling off of the solid electrolytic layer is suppressed and reliability of a solid electrolytic capacitor is improved.

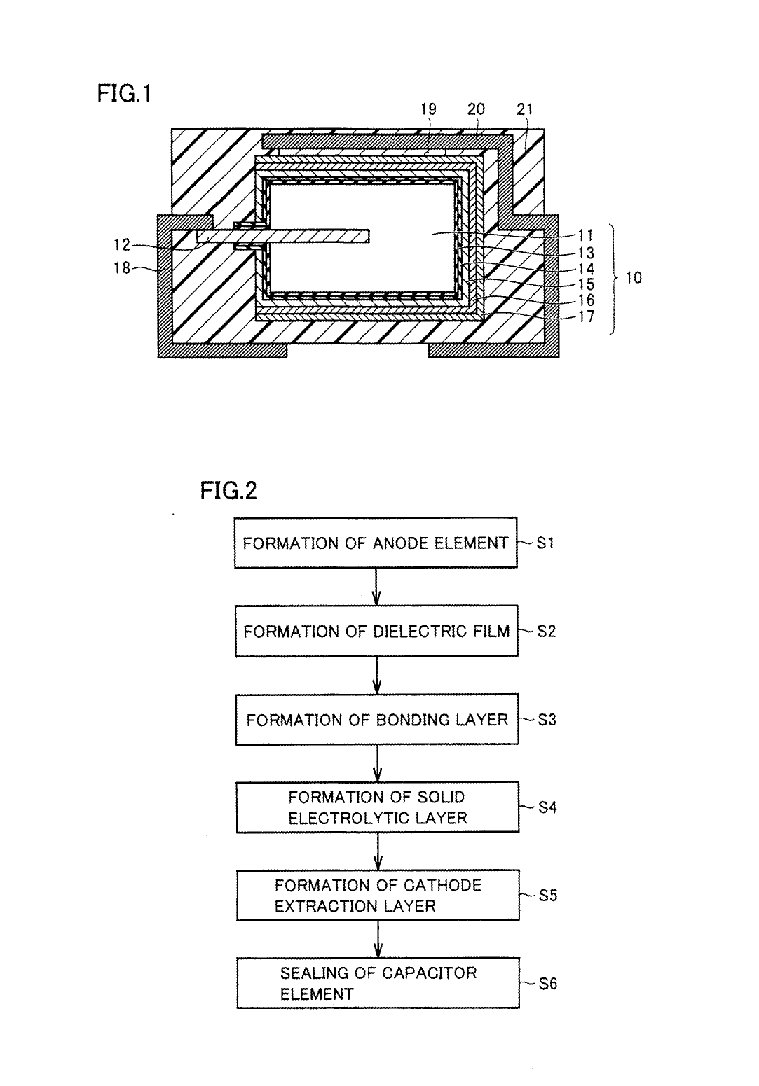

Specifically, the present inventor has fabricated what is called a stack type solid electrolytic capacitor by preparing an anode element having a CV value around 100000 μFV/g and formed of a sintered body of tantalum particles and forming a bonding layer with the use of a silane coupling agent (see FIG. 1). It has been confirmed, however, that the solid electrolytic capacitor above tends to be faster in lowering in capacitance in spite of its higher initial capacitance, than a conventional solid electrolytic capacitor, that is, a solid electrolytic capacitor including a bonding layer and an anode element having a CV value around 50000 μFV/g and formed of a sintered body of tantalum particles.

Then, the present inventor has conducted dedicated studies by using several types of valve metal particles different in particle size, and has confirmed that, as a particles size is smaller, in other words, as a CV value of an anode element is higher, a degree of lowering in capacitance tends to be higher. In view of this tendency, the present inventor has assumed that, as a particle size of valve metal particles is smaller, a function of a bonding layer containing a silane coupling agent has lowered, and further conducted dedicated studies based on the assumption. Then, the present inventor has found that a bonding layer could not sufficiently be formed on a surface of an anode element because a silane coupling agent is less likely to permeate into the anode element formed of a sintered body as a particle size of valve metal particles is smaller, and consequently reliability of the solid electrolytic capacitor has lowered.

The present inventor has further conducted dedicated studies based on the findings above, and thus completed the invention of a method of manufacturing a highly reliable solid electrolytic capacitor having a desired bonding layer formed, which is capable of causing a silane coupling agent to sufficiently permeate even into the inside of an anode element having a high CV value and containing valve metal particles small in particle size.

An embodiment of a method of manufacturing a solid electrolytic capacitor according to the present invention will be described hereinafter with reference to FIGS. 1 to 7. The embodiment below is by way of example and the present invention can be carried out in various embodiments within the scope of the present invention. It is noted that, in the drawings of the present invention, the same or corresponding elements have the same reference characters allotted.

### First Embodiment

A construction of a solid electrolytic capacitor manufactured with the manufacturing method according to the present embodiment will initially be described with reference to FIG. 1.

In FIG. 1, a solid electrolytic capacitor includes a capacitor element 10 having a dielectric film 13, a bonding layer 14, a solid electrolytic layer 15, and a carbon layer 16 and a silver paint layer 17 successively formed on a surface of an anode element 11 on which an anode lead 12 is erected. One end of anode lead 12 exposed through anode element 11 is electrically connected to an anode terminal 18, and silver paint layer 17 is electrically connected to a cathode terminal 20 through an adhesive layer 19. Then, capacitor element 10, one end side of anode terminal 18 connected to anode lead 12, and one end side of cathode terminal 20 connected to adhesive layer 19 are sealed with an exterior resin 21.

One example of the method of manufacturing a solid electrolytic capacitor above will now be described with reference to FIGS. 1 to 3.

(Step of Forming Anode Element)

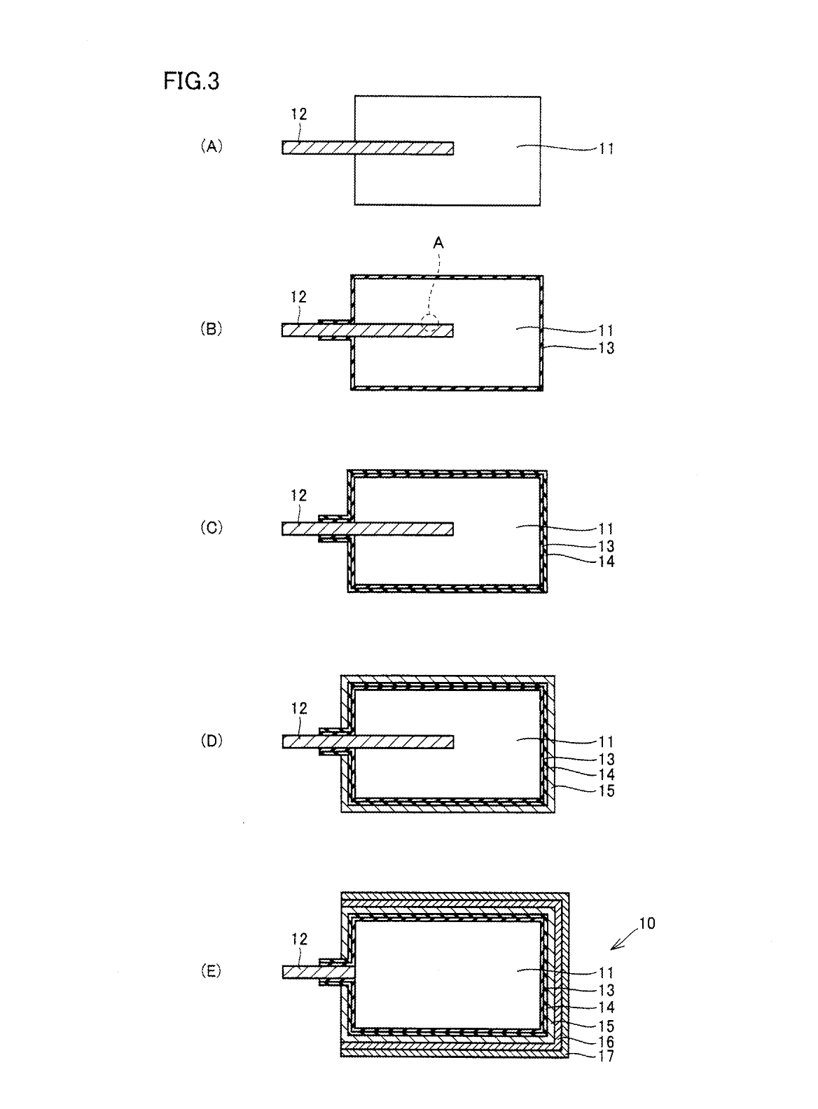

Initially, as shown in FIGS. 2 and 3(A), anode element 11 on which the anode lead is erected is formed (step S1). For example, anode element 11 in FIG. 2 can be formed as follows.

Namely, initially, valve metal particles are prepared. Then, the valve metal particles are molded in a desired shape such as a parallelepiped shape such that one end side of rod-shaped anode lead 12 is buried in the valve metal particles above. Then, by sintering the molded particles, anode element 11 made of a sintered body and having a porous structure is formed.

A CV value of anode element 11 is not particularly restricted. Normally used anode element 11 having a CV value around 50000 μFV/g may be formed or anode element 11 having a CV value not lower than 100000 μFV/g may be formed by using valve metal particles small in particle size. It is noted that anode element 11 having a CV value not lower than 100000 μFV/g is preferably formed because an effect of the present invention can more significantly be exhibited in a solid electrolytic capacitor having anode element 11 formed with valve metal particles small in particle size and having a high CV value. For example, by using valve metal particles having a particle size not greater than 1 μm, anode element 11 having a CV value not lower than 100000 μFV/g can readily be formed. Valve metal particles having a particle size not greater than 0.5 μm are more preferably used. It is noted that tantalum (Ta), niobium (Nb), titanium (Ti), aluminum (Al), or the like can be employed as a valve metal. In terms of less leakage current in a solid electrolytic capacitor, Ta is more preferably used.

Though a material for anode lead 12 is not particularly limited, a metal commonly used for anode element 11 is preferably used in terms of a manufacturing process. In addition, a material forming a surface of anode lead 12 may be a metal the same as that for anode element 11.

(Step of Forming Dielectric Film)

Then, as shown in FIGS. 2 and 3(B), dielectric film 13 is formed on the surface of anode element 11 (step S2). For example, dielectric film 13 can be formed as follows.

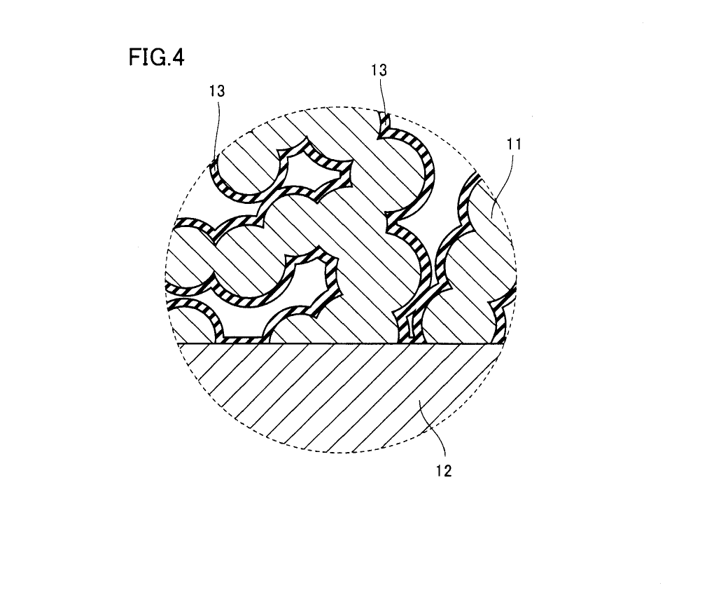

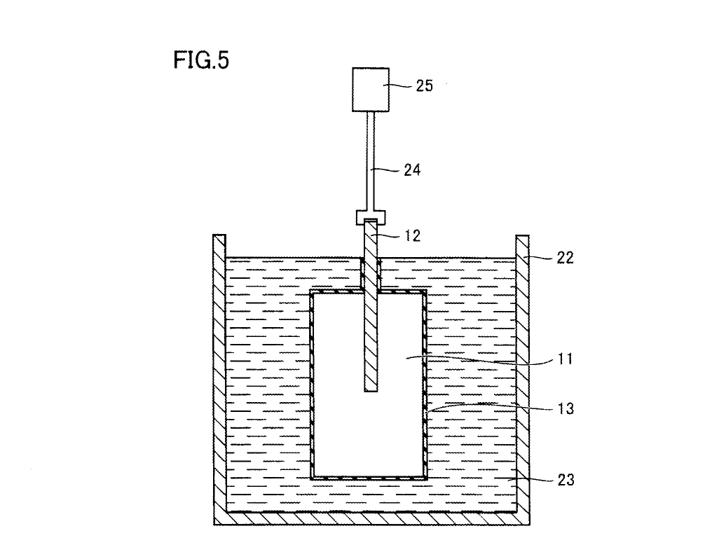

Namely, initially, anode element 11 is immersed in a chemical conversion treatment solution such as an ammonium adipate aqueous solution, a phosphoric acid aqueous solution, or a nitric acid aqueous solution, and a voltage is applied to anode element 11. Thus, a valve metal forming a surface portion of anode element 11 is converted to an oxide to thereby form dielectric film 13 composed of an oxide of a metal forming anode element 11. As shown in FIG. 4, dielectric film 13 covers the entire surface of anode element 11 formed of a sintered body and having a porous structure. Specifically, in a case where anode element 11 is composed of Ta, Nb, or Al, dielectric film 13 is composed of tantalum oxide (Ta₂O₅), niobium oxide (Nb₂O₅), or aluminum oxide (Al₂O₃).

(Step of Forming Bonding Layer)

Then, as shown in FIGS. 2 and 3(C), bonding layer 14 containing a silane compound is formed on dielectric film 13 (step S3). Bonding layer 14 can be formed, for example, by including in the present step, the step of vibrating anode element 11 as shown in FIG. 5. The step of vibrating an anode element will be described hereinafter with reference to FIG. 5.

In FIG. 5, a bath 22 contains a solution 23 containing a silane coupling agent. A holder 24 capable of holding anode element 11 is arranged above bath 22, and holder 24 can hold and release anode element 11 under the control by a control unit 25 and can vibrate held anode element 11 in a vertical direction in the figure. It is noted that FIG. 5 exemplifies a case where holder 24 holds anode element 11 by clamping one end of anode lead 12.

Referring to FIG. 5, initially, solution 23 containing a silane coupling agent is contained in bath 22. The silane coupling agent is not particularly limited so long as it forms bonding layer 14 on dielectric film 13 and improves adhesion between dielectric film 13 and solid electrolytic layer 15. Specifically, vinyl trichlorosilane, vinyl (β-methoxysilane), vinyltriethoxysilane, γ-methacryloxysilane, β-(3,4-epoxy cyclohexyl)ethyltrimethoxysilane, γ-glycidoxypropyltrimethoxysilane, N-β-(aminoethyl)-γ-aminopropylmethyldimethoxysilane, N-β-(aminoethyl)-γ-aminopropyltrimethoxysilane, γ-aminopropyltriethoxysilane, N-phenyl-γ-aminopropyltrimethoxysilane, γ-mercaptopropyltrimethoxysilane, γ-chloropropyltrimethoxysilane, or the like can be employed.

Concentration of the silane coupling agent above in solution 23 is preferably not lower than 0.1 mass % and not higher than 50 mass %. When concentration of the silane coupling agent above in solution 23 is not lower than 0.1 mass %, efficiency in forming bonding layer 14 can sufficiently be kept. When concentration of the silane coupling agent above in solution 23 is not higher than 50 mass %, excessively high viscosity of solution 23 can be suppressed. In addition, concentration of the silane coupling agent in solution 23 is further preferably not higher than 10 mass %. It is noted that water is preferably used as a solvent for solution 23.

Then, control unit 25 causes anode element 11 held by holder 24 to be immersed in solution 23 and causes immersed anode element 11 to vibrate. Since anode element 11 has a porous structure, solution 23 may be less likely to permeate into a deep portion inside. In particular, in the case where anode element 11 is formed of a valve metal small in particle size, solution 23 is further less likely to permeate. In contrast, according to the present step, since anode element 11 immersed in solution 23 is vibrated, degassing of anode element 11 efficiently proceeds and in addition, by vibration, solution 23 is more likely to permeate into the inside of anode element 11. Thus, consequently, solution 23 can sufficiently permeate into the inside of anode element 11.

Then, by pulling anode element 11 into which solution 23 has sufficiently permeated out of bath 22 and evaporating water which is the solvent, bonding layer 14 containing a silane compound is formed on dielectric film 13. As described above, since solution 23 containing the silane coupling agent has sufficiently permeated into the inside of anode element 11, bonding layer 14 can sufficiently be formed also in the inside of anode element 11.

In the step of vibrating the anode element above, a frequency (Hz) of vibration and an amplitude (mm) should only cause vibration to such an extent that excessive load is not imposed on anode element 11. Specifically, a frequency lower than 500 Hz is preferred. By setting the frequency lower than 500 Hz, damage or the like due to excessive load imposed on anode element 11 can be suppressed. In addition, the frequency is preferably not lower than 10 Hz. By setting the frequency not lower than 10 Hz, solution 23 can sufficiently permeate in deep inside anode element 11. Moreover, an amplitude is preferably not smaller than 1 mm and not greater than 10 mm, although depending on a dimension of anode element 11. By setting amplitude not smaller than 0.1 mm, sufficient permeation of solution 23 is allowed. By setting amplitude not greater than 10 mm, damage or the like due to excessive load imposed on anode element 11 can be suppressed.

Though the case where anode element 11 is vibrated in the vertical direction in the figure has been described above with reference to FIG. 5, anode element 11 may be vibrated in a lateral direction in the figure or it may be vibrated in a manner rotating in solution 23. Alternatively, vibration may be combination of such movements. Alternatively, in addition to or instead of vibration of anode element 11, solution 23 may be vibrated.

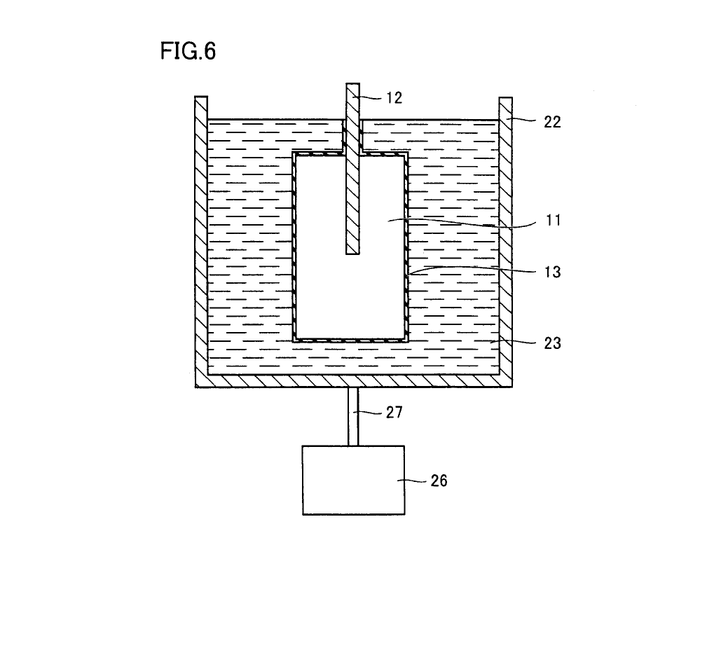

For example, as shown in FIG. 6, by vibrating bath 22 in the vertical direction, the lateral direction, and the like in the figure under the control by a drive portion 26 for driving a support portion 27 for supporting bath 22, solution 23 can be vibrated relative to anode element 11. In this case, however, since it is necessary to control spilling of solution 23 out of bath 22, the method of vibrating anode element 11 described above is easier to control.

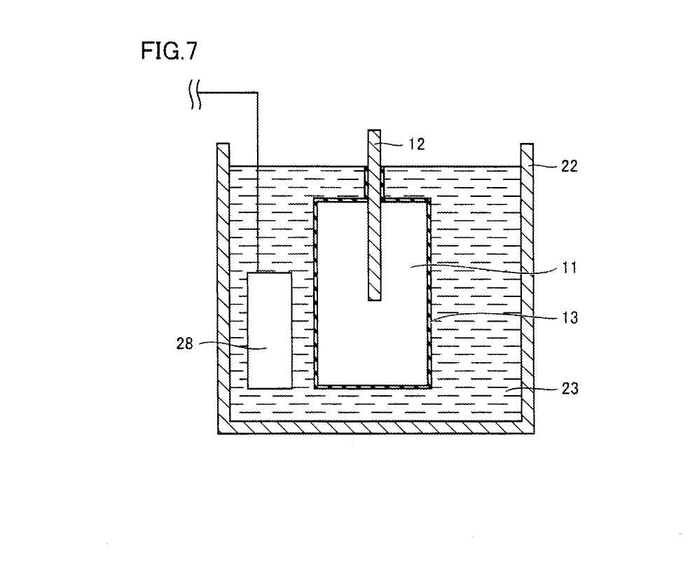

In addition, bonding layer 14 can be formed, for example, by including in the present step, the step of heating a solution as shown in FIG. 7. The step of heating a solution will be described hereinafter with reference to FIG. 7.

In FIG. 7, bath 22 contains solution 23 containing a silane coupling agent. In addition, a heating element 28 for heating solution 23 is arranged in bath 22. It is noted that FIG. 7 does not show a holder for holding anode element 11.

Referring to FIG. 7, initially, solution 23 containing a silane coupling agent is contained in bath 22. Since a type, concentration, and a solvent of the silane coupling agent are the same as described above, description thereof will not be repeated.

Then, anode element 11 is immersed in solution 23 and heating element 28 heats solution 23. It is noted that anode element 11 may be immersed in solution 23 heated by heating element 28. According to the present step, since viscosity of solution 23 lowers as it is heated, solution 23 is more likely to permeate into the inside of anode element 11. Thus, consequently, solution 23 can permeate sufficiently into the inside of anode element 11.

Then, by pulling anode element 11 into which solution 23 has sufficiently permeated out of bath 22 and evaporating water which is the solvent, bonding layer 14 containing a silane compound is formed on dielectric film 13. As described above, since solution 23 containing the silane coupling agent has sufficiently permeated into the inside of anode element 11, bonding layer 14 can sufficiently be formed also in the inside of anode element 11.

In the heating step above, a heating temperature is preferably lower than 100° C. The heating temperature is set as such for suppressing change in composition and characteristics of solution 23, because the solvent for solution 23 is water and hence the solvent evaporates as it is heated at a temperature equal to or higher than 100° C. In addition, a heating temperature is more preferably lower than 95° C. and further preferably not higher than 90° C. In this case, evaporation of a solvent can further effectively be suppressed.

Though the step of heating solution 23 has been described above with reference to FIG. 7, the step of vibrating at least one of anode element 11 and solution 23 described above and the step of heating solution 23 may be combined with each other. Namely, anode element 11 may be immersed in solution 23 to be heated and then at least one of anode element 11 and solution 23 may be vibrated. In this case, solution 23 can permeate more effectively into the inside of anode element 11. In addition, since solution 23 can permeate into the inside of anode element 11 more quickly, a manufacturing cycle time can be reduced.

As described above in detail, through the present step, bonding layer 14 can be formed even in the inside of anode element 11. It is noted that, after the present step, in order to remove a silane coupling agent which has not been polymerized, anode element 11 may be washed with water or the like and then dried. Bonding layer 14 formed in the present step does not have to cover the entire surface of dielectric film 13 formed on the surface of anode element 11, and for example, it may scatter on dielectric film 13.

(Step of Forming Solid Electrolytic Layer)

Then, as shown in FIGS. 2 and 3(D), solid electrolytic layer 15 is formed on dielectric film 13 and bonding layer 14 (step S4). Solid electrolytic layer 15 is preferably composed of manganese dioxide, TCNQ complex salt (7,7,8,8-tetracyanoquinodimethane), a conductive polymer, or the like. Here, one example of a method of forming a pre-coating layer and then forming solid electrolytic layer 15 composed of a conductive polymer will be described.

Namely, initially, a conductive pre-coating layer (not shown) is formed on anode element 11 having dielectric film 13 formed. Though formation of a pre-coating layer is not essential, solid electrolytic layer 15 composed of a conductive polymer can readily be formed with an electrolytic polymerization method on dielectric film 13 and the pre-coating layer, by forming a conductive pre-coating layer on dielectric film 13. Though solid electrolytic layer 15 composed of a conductive polymer can be formed with any method of the electrolytic polymerization method and a chemical polymerization method, solid electrolytic layer 15 formed with the electrolytic polymerization method has a dense and homogenous structure, which is preferred.

The pre-coating layer above can readily be formed, for example, with the chemical polymerization method. It is noted that, in this case, the pre-coating layer will be composed of a conductive polymer. With the chemical polymerization method, by immersing anode element 11 in a polymerization solution containing a precursor of a polymer (for example, a precursor monomer), a dopant, and an oxidizing agent and then pulling up anode element 11, a conductive polymer can be grown on the surface of anode element 11. One liquid containing all the substances above or two liquids may be adopted as the polymerization solution. For example, in the case of carrying out chemical polymerization with two liquids of a first polymerization solution containing a precursor and a second polymerization solution containing a dopant and an oxidizing agent, anode element 11 should only be immersed sequentially in each polymerization solution. It is noted that the pre-coating layer may cover the entire surface of dielectric film 13, or it may scatter on the surface of dielectric film 13, for example, so as to partially cover dielectric film 13.

Then, solid electrolytic layer 15 composed of a conductive polymer is formed on the pre-coating layer. As described above, owing to the presence of the pre-coating layer, dense and homogenous solid electrolytic layer 15 can readily be formed on dielectric film 13 and the pre-coating layer with the electrolytic polymerization method. With the electrolytic polymerization method, by immersing anode element 11 in an electrolyte containing a precursor of a polymer and a dopant and then feeding a current to this electrolyte, solid electrolytic layer 15 composed of a conductive polymer can homogenously be formed on dielectric film 13 and the pre-coating layer.

In present one example, a conductive polymer forming the pre-coating layer and a conductive polymer forming solid electrolytic layer 15 may be identical to or different from each other. For a precursor of the conductive polymer above, for example, 3,4-ethylenedioxythiophene, 3-alkylthiophene, N-methylpyrrole, N,N-dimethylaniline, N-alkylaniline, or the like can be employed.

In addition, a dopant is not particularly limited, and for example, a sulfonic acid compound such as alkyl sulfonic acid, aromatic sulfonic acid or polycyclic aromatic sulfonic acid may be employed, or nitric acid, sulfuric acid, or the like may be employed. Moreover, an oxidizing agent should only be capable of polymerizing a precursor, and for example, sulfuric acid, hydrogen peroxide, iron (III), copper (II), chromium (VI), cerium (IV), manganese (VII), zinc (II), or the like can be employed. It is noted that aromatic sulfonic acid metal salt forming salt together with such a metal has not only a function as an oxidizing agent but also a function as a dopant. Furthermore, a solvent for a polymerization solution and an electrolyte is not particularly limited, and a water-based solvent such as water and ultrapure water, a non-water-based solvent such as an organic solvent, or the like can be employed.

Through the present step, solid electrolytic layer 15 composed of any such conductive polymer that polythiophene and derivatives thereof, polypyrrole and derivatives thereof, polyaniline and derivatives thereof, and polyfuran and derivatives thereof are provided with conductivity can be formed. It is noted that solid electrolytic layer 15 composed of a conductive polymer may naturally be formed with the chemical polymerization method.

In the present embodiment, bonding layer 14 is formed on dielectric film 13 and bonding layer 14 is formed also on dielectric film 13 located in the inside of anode element 11. Therefore, adhesion between dielectric film 13 and solid electrolytic layer 15 can sufficiently be enhanced by bonding layer 14 also in the inside of anode element 11. In particular, in the case where solid electrolytic layer 15 is composed of a conductive polymer as in the present embodiment, adhesion between dielectric film 13 composed of an inorganic substance and solid electrolytic layer 15 composed of an organic substance tends to be low. Therefore, in this case, an effect achieved by bonding layer 14 is further significant.

(Step of Forming Cathode Extraction Layer)

Then, as shown in FIGS. 2 and 3(E), a cathode extraction layer constituted of carbon layer 16 and silver paint layer 17 is formed on solid electrolytic layer 15 (step S5). The cathode extraction layer can be formed, for example, as follows.

Namely, initially, anode element 11 having solid electrolytic layer 15 formed is immersed in a dispersion in which carbon particles such as graphite have been dispersed, followed by drying treatment. Thus, carbon layer 16 is formed on solid electrolytic layer 15. Then, anode element 11 having carbon layer 16 formed is immersed in a dispersion in which silver particles have been dispersed, followed by drying treatment. Thus, silver paint layer 17 is formed on carbon layer 16. Through the present step, the cathode extraction layer is formed and capacitor element 10 is formed through steps S1 to S5.

(Step of Sealing Capacitor Element)

Then, as shown in FIGS. 1 and 2, capacitor element 10 is sealed to fabricate a solid electrolytic capacitor (step S6). Though a sealing method is not particularly limited, for example, the following method is available.

Namely, initially, anode terminal 18 is connected to one end of anode lead 12 exposed through anode element 11, and adhesive layer 19 is formed on silver paint layer 17, to which one end of cathode terminal 20 is connected. Then, capacitor element 10 is sealed with exterior resin 21 such that the other ends of anode terminal 18 and cathode terminal 20 are exposed. Then, exposed anode terminal 18 and cathode terminal 20 are bent along exterior resin 21, followed by aging treatment, to thereby manufacture a solid electrolytic capacitor shown in FIG. 1.

Anode terminal 18 and cathode terminal 20 should only have conductivity, and for example, such a metal as copper can be employed. Adhesive layer 19 should only have conductivity and adhesiveness, and for example, a silver adhesive containing silver as a filler can be employed. A material for exterior resin 21 is not particularly limited, and a known resin such as epoxy resin can be employed.

According to the method of manufacturing a solid electrolytic capacitor in the first embodiment described above in detail, bonding layer 14 composed of a silane compound is formed on dielectric film 13. In particular, in the step of forming bonding layer 14, at least one of immersing anode element 11 in solution 23 containing a silane coupling agent and vibrating anode element 11 and solution 23 relative to each other, and immersing anode element 11 in solution 23 and heating solution 23 is carried out. Thus, solution 23 can permeate into the inside of pores in anode element 11 having a porous structure.

For example, simply by immersing an anode element in a solution containing a silane coupling agent as in the conventional example, a solution may not be able to permeate in deep inside the anode element, depending on viscosity of the solution, a dimension of pores in the anode element, and such relation as wettability between the dielectric film and the solution. The present inventor has found that such a case is more significant as a particle size of valve metal particles serving as a source material for the anode element is smaller.

In contrast, in the present first embodiment, solution 23 can permeate in deep inside anode element 11 as described above, and therefore a bonding layer can more uniformly be formed on dielectric film 13. Thus, peeling off of solid electrolytic layer 15 can efficiently be suppressed and consequently reliability of a solid electrolytic capacitor can be improved. In particular, in the case where anode element 11 having a CV value not lower than 100000 μFV/g and formed of a sintered body of valve metal particles is fabricated, a solid electrolytic capacitor achieving both of increase in capacitance and improvement in reliability, which has been substantially difficult to achieve with the conventional manufacturing method, can be manufactured.

### Second Embodiment

Since the present embodiment is different from the first embodiment only in formation of bonding layer 14 after formation of a pre-coating layer, only the difference will be described.

Namely, a pre-coating layer is formed with the chemical polymerization method on anode element 11 having dielectric film 13 formed. In the present embodiment, the pre-coating layer does not cover the entire surface of dielectric film 13 but it partially covers dielectric film 13. Therefore, even when bonding layer 14 is formed after formation of the pre-coating layer, bonding layer 14 can be formed not only on the pre-coating layer but also on dielectric film 13 not covered with the pre-coating layer.

In the present second embodiment as well, as in the first embodiment, since solution 23 can permeate in deep inside anode element 11, bonding layer 14 can more uniformly be formed on dielectric film 13. Therefore, peeling off of solid electrolytic layer 15 can efficiently be suppressed and consequently reliability of a solid electrolytic capacitor can be improved.

### EXAMPLES

The present invention will be described hereinafter in further detail with reference to Examples, however, the present invention is not limited thereto.

### Discussion 1

### Example 1

Initially, tantalum powders were prepared, and the tantalum powders were molded in a parallelepiped shape while one end side in a longitudinal direction of the anode lead in a rod shape made of tantalum was buried in the tantalum powders. Then, by sintering the molded powders, the anode element having a porous structure, in which one end of the anode lead had been buried, was fabricated. The formed anode element had a CV value of 100000 μFV/g.

Then, the anode element was immersed in a 0.02 mass % phosphoric acid aqueous solution and a voltage of 20 V was applied to the anode element through the anode lead for 5 hours. Thus, the dielectric film composed of Ta₂O₅ was formed on the surface of the anode element.

Then, γ-glycidoxypropyltrimethoxysilane serving as the silane coupling agent was added to water to thereby prepare an aqueous solution having concentration of the silane coupling agent of 5 mass %. Then, the anode element was immersed in the aqueous solution, and the anode element was vibrated in the vertical direction with respect to the surface of the aqueous solution for 10 minutes at a frequency of 5 Hz and an amplitude of 3 mm. It is noted that a temperature of the aqueous solution here was set to a room temperature (25° C.). Then, water was evaporated by pulling the anode element out of the aqueous solution and letting it stand at the room temperature. Thus, a bonding layer composed of a silane compound was formed.

Then, a conductive pre-coating layer was formed on the dielectric film with the chemical polymerization method. Specifically, initially, an ethanol solution containing pyrrole at concentration of 3 mol/l and an aqueous solution containing ammonium persulfate and p-toluenesulfonate were prepared as polymerization solutions. Then, the anode element was sequentially immersed in and pulled out of the ethanol solution and the aqueous solution, and it was let stand at the room temperature. Thus, the pre-coating layer composed of polypyrrole was formed.

Then, a solid electrolytic layer was formed on the dielectric film and the pre-coating layer with the electrolytic polymerization method. Specifically, initially, an aqueous solution containing 3 mol/l of pyrrole and alkylnaphthalenesulfonic acid was prepared as an electrolyte. Then, an electrolytic cell in an electrolytic polymerization apparatus was filled with the aqueous solution, in which the anode element was immersed, and a 0.5 mA current was fed to the pre-coating layer for 3 hours. Thus, the solid electrolytic layer composed of polypyrrole was formed on the dielectric film.

Then, a graphite particle suspension was applied onto the solid electrolytic layer followed by drying in atmosphere. Thus, the carbon layer was formed. Further, a solution containing silver particles was applied onto the carbon layer followed by drying in atmosphere. Thus, the silver paint layer was formed. A capacitor element was fabricated as above.

Then, in the capacitor element, the anode terminal made of a metal was welded to the anode lead. A silver adhesive was applied to the silver paint layer to form an adhesive layer, and one end of a cathode terminal made of a metal was bonded to the adhesive layer. Further, the capacitor element was sealed with an exterior resin composed of epoxy resin such that a part of the anode terminal and the cathode terminal was exposed. After the anode terminal and the cathode terminal exposed through the exterior resin were bent along the exterior resin, they were subjected to aging treatment. Thus, 10 solid electrolytic capacitors were fabricated.

### Example 2

Ten solid electrolytic capacitors were fabricated with a method the same as in Example 1 except for forming a bonding layer with a frequency of the anode element being set to 10 Hz.

### Example 3

Ten solid electrolytic capacitors were fabricated with a method the same as in Example 1 except for forming a bonding layer with a frequency of the anode element being set to 100 Hz.

### Example 4

Ten solid electrolytic capacitors were fabricated with a method the same as in Example 1 except for forming a bonding layer with a frequency of the anode element being set to 500 Hz.

### Comparative Example 1

Ten solid electrolytic capacitors were fabricated with a method the same as in Example 1 except for forming a bonding layer without vibrating the solution.

### Reference Example 1

Ten solid electrolytic capacitors were fabricated with a method the same as in Example 1 except for forming an anode element having a CV value of 50000 μFV/g with the use of tantalum powders and forming a bonding layer without vibrating the solution.

(LIFE Test)

Each manufactured solid electrolytic capacitor was subjected to a LIFE test. Specifically, initial (a time period of use being 0 hours) capacitance of each solid electrolytic capacitor was measured. Thereafter, the solid electrolytic capacitor was placed in a thermostat at 105° C., and application of a rated voltage to each solid electrolytic capacitor was continued in the thermostat. Then, capacitance of each solid electrolytic capacitor after lapse of 500 hours of application duration was measured and an extent of change was observed. A method of measuring capacitance is as follows.

Namely, 5 solid electrolytic capacitors were selected from the solid electrolytic capacitors. Capacitance (μF) at a frequency of 120 Hz, of each selected solid electrolytic capacitor was measured by using an LCR meter for 4-terminal measurement. Then, with capacitance of the solid electrolytic capacitor for an application duration (h) of 0 hours being denoted as C and capacitance of the solid electrolytic capacitor after lapse of 500 hours of application duration being denoted as C_{X}, a rate of change in capacitance ΔC/C (%) was calculated based on Equation (1) below.

ΔC/C (%)=(C_{X}−C)/C×100 Equation (1)

TABLE 1

| | CV Value of | Temperature | | Rate of |
|---|---|---|---|---|
| | Anode Element | of Solution | Frequency | Change |
| | (μFV/g) | (° C.) | (Hz) | (ΔC/C(%)) |
| Example 1 | 100,000 | 25 | 5 | −15 |
| Example 2 | 100,000 | 25 | 10 | −4.8 |
| Example 3 | 100,000 | 25 | 100 | −4.3 |
| Example 4 | 100,000 | 25 | 500 | — |
| Comparative | 100,000 | 25 | — | −18 |
| Example 1 | | | | |
| Reference | 50,000 | 25 | — | −4.5 |
| Example 1 | | | | |

(Evaluation)

Table 1 shows results. It is noted that each numeric value represents an average value of solid electrolytic capacitors in each Example, Comparative Example, and Reference Example. Referring to Table 1, it was found that, in the case where the solution was not vibrated during formation of the bonding layer (Comparative Example 1), capacitance after the LIFE test significantly lowered. In contrast, it was found that, when the solution was vibrated (Examples 1 to 4), lowering in capacitance could be suppressed and hence reliability of the solid electrolytic capacitor improved. It is understood that these results were obtained because peeling off of the solid electrolytic layer was suppressed, which was because of sufficient permeation of the solution into the inside of the anode element.

In addition, based on comparison among Examples 1 to 4, it was found that lowering in capacitance could more efficiently be suppressed when the frequency was from 10 Hz to 100 Hz. Meanwhile, when the frequency was set to 500 Hz, although there were also solid electrolytic capacitors of which lowering in capacitance was suppressed, many solid electrolytic capacitors experienced increase in an amount of leaked current because of damage to the anode element during vibration. For example, an initial amount of a leaked current of the solid electrolytic capacitor in Example 2 was 80.6 μA at the maximum, whereas an initial amount of a leaked current of the solid electrolytic capacitor in Example 4 was 1236 μA at the maximum. Therefore, in the case where the frequency was set to 500 Hz or higher, sufficient attention should be paid in the vibration step. Therefore, it was found that the frequency was preferably lower than 500 Hz from a point of view of improvement in yield and manufacturing efficiency.

Moreover, referring to Reference Example 1, after lapse of the LIFE test for 500 hours, significant lowering in capacitance was not observed. This may be because a particle size of tantalum powders was large and hence pores in the anode element were greater than pores in the anode element in Examples and the solution was more likely to permeate into the inside of the anode element, and consequently a sufficient bonding layer capable of withstand use could be formed. Even when a particle size of the tantalum powders is great, however, a possibility remains that a solution cannot permeate in deep inside the anode element which can have a complicated and inhomogeneous structure. For example, depending on difference in concentration of a solution, difference in a lot of an anode element, or the like, manufacturing yield of a solid electrolytic capacitor having desired characteristics may lower. Therefore, it is understood that there is an effect achieved by vibrating the solution and the anode element relative to each other, even in the case of an anode element composed of valve metal particles relatively large in particles size, in other words, an anode element having a CV value not lower than 50000 μFV/g and lower than 100000 μFV/g.

### Discussion 2

### Example 5

Ten solid electrolytic capacitors were fabricated with a method the same as in Example 2 except for forming an anode element having a CV value of 150000 μFV/g with the use of tantalum powders.

### Example 6

Ten solid electrolytic capacitors were fabricated with a method the same as in Example 3 except for forming an anode element having a CV value of 150000 μFV/g with the use of tantalum powders.

### Comparative Example 2

Ten solid electrolytic capacitors were fabricated with a method the same as in Comparative Example 1 except for forming an anode element having a CV value of 150000 μFV/g with the use of tantalum powders.

TABLE 2

| | CV Value of | Temperature | | Rate of |
|---|---|---|---|---|
| | Anode Element | of Solution | Frequency | Change |
| | (μFV/g) | (° C.) | (Hz) | (ΔC/C(%)) |
| Example 5 | 150,000 | 25 | 10 | −7.0 |
| Example 6 | 150,000 | 25 | 100 | −6.5 |
| Comparative | 150,000 | 25 | — | −25 |
| Example 2 | | | | |

(Evaluation)

Table 2 shows results of a LIFE test as described above by using each manufactured solid electrolytic capacitor. It is noted that each numeric value represents an average value of solid electrolytic capacitors in each Example and Comparative Example. Referring to Table 2, it was found that, in the case where the solution was not vibrated during formation of the bonding layer (Comparative Example 2), capacitance after the LIFE test significantly lowered. In contrast, it was found that, in the case where the solution was vibrated (Examples 5 and 6), lowering in capacitance could be suppressed.

In addition, based on comparison between Tables 1 and 2, it was found that, as a particle size of the tantalum powders was smaller, that is, a CV value of the anode element was greater, a rate of change in capacitance increased and an effect of lowering in rate of change owing to vibration was also great. Therefore, it was found that, when an anode element having a CV value not higher than 100000 μFV/g was employed, an effect achieved by vibration of the anode element and the solution relative to each other was more significant

### Discussion 3

### Example 7

A solid electrolytic capacitor was fabricated with a method the same as in Example 1 except for heating of the solution to 50° C. and immersion for 10 minutes instead of vibration of the solution in the step of forming a bonding layer.

### Example 8

A solid electrolytic capacitor was fabricated with a method the same as in Example 7 except for heating of the solution to 90° C.

### Example 9

A solid electrolytic capacitor was fabricated with a method the same as in Example 7 except for heating of the solution to 95° C.

### Example 10

A solid electrolytic capacitor was fabricated with a method the same as in Example 7 except for forming an anode element having a CV value of 150000 μFV/g with the use of tantalum powders.

### Example 11

A solid electrolytic capacitor was fabricated with a method the same as in Example 8 except for forming an anode element having a CV value of 150000 μFV/g with the use of tantalum powders.

TABLE 3

| | CV Value of | Temperature | | Rate of |
|---|---|---|---|---|
| | Anode Element | of Solution | Frequency | Change |
| | (μFV/g) | (° C.) | (Hz) | (ΔC/C(%)) |
| Example 7 | 100,000 | 50 | — | −5.9 |
| Example 8 | 100,000 | 90 | — | −5.4 |
| Example 9 | 100,000 | 95 | — | — |
| Comparative | 100,000 | 25 | — | −18 |
| Example 1 | | | | |
| Example 10 | 150,000 | 50 | — | −8.8 |
| Example 11 | 150,000 | 90 | — | −7.8 |
| Comparative | 150,000 | 25 | — | −25 |
| Example 2 | | | | |

(Evaluation)

Table 3 shows results of a LIFE test as described above by using each manufactured solid electrolytic capacitor. It is noted that each numeric value represents an average value of solid electrolytic capacitors in each Example and Comparative Example, and for facilitating comparison, results in Comparative Examples 1 and 2 are also shown. Referring to Table 3, it was found that, by heating the solution, lowering in capacitance could be suppressed and hence reliability of the solid electrolytic capacitor improved.

In addition, when the solution was heated to 95° C., though there were some solid electrolytic capacitors of which lowering in capacitance was suppressed, variation thereamong tended to be great. This may be because water containing the silane coupling agent started to gradually evaporate and composition of the solution became unstable because of heating to 95° C., in spite of a boiling point of water being 100° C.

Therefore, in the case where the solution is heated to 95° C. or higher, sufficient attention should be paid in the heating step. Therefore, it was found that the heating temperature was preferably lower than 95° C. from a point of view of improvement in yield and manufacturing efficiency.

### Discussion 4

### Example 12

A solid electrolytic capacitor was fabricated with a method the same as in Example 7 except for heating the solution and vibrating the anode element in the vertical direction with respect to the surface of the aqueous solution for 10 minutes at a frequency of 10 Hz and an amplitude of 3 mm in the step of forming a bonding layer.

### Example 13

A solid electrolytic capacitor was fabricated with a method the same as in Example 12 except for forming an anode element having a CV value of 150000 μFV/g with the use of tantalum powders.

TABLE 4

| | CV Value of | Temperature | | Rate of |
|---|---|---|---|---|
| | Anode Element | of Solution | Frequency | Change |
| | (μFV/g) | (° C.) | (Hz) | (ΔC/C(%)) |
| Example 12 | 100,000 | 50 | 10 | −4.1 |
| Example 13 | 150,000 | 50 | 10 | −6.0 |

(Evaluation)

Table 4 shows results of a LIFE test as described above by using each manufactured solid electrolytic capacitor. It is noted that each numeric value represents an average value of solid electrolytic capacitors in each Example and Comparative Example. Referring to Table 4, it was found that, by vibrating the solution and the anode element relative to each other while the solution was heated in the step of forming a bonding layer, a rate of change in capacitance of the solid electrolytic capacitor could further be lowered.

Though the embodiments and the examples of the present invention have been described as above, combination of the features in the embodiments and the Examples as appropriate is also originally intended.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A method of manufacturing a solid electrolytic capacitor, comprising in this order, the steps of:
forming a dielectric film on a surface of an anode element formed of a porous body;
forming a bonding layer containing a silane compound on said dielectric film; and
forming a solid electrolytic layer on said dielectric film,
said step of forming a bonding layer including at least any one step of the step of immersing said anode element in a solution containing a silane coupling agent and vibrating at least any one of said anode element and said solution and the step of immersing said anode element in said solution and heating said solution.

2. The method of manufacturing a solid electrolytic capacitor according to claim 1, wherein
said anode element is a sintered body having a CV value not lower than 100000 μFV/g.

3. The method of manufacturing a solid electrolytic capacitor according to claim 1, wherein
said dielectric film is composed of a metal oxide and said solid electrolytic layer is formed from a conductive polymer layer.

4. The method of manufacturing a solid electrolytic capacitor according to claim 1, wherein
concentration of said silane coupling agent in said solution is not lower than 0.1 mass %.

5. The method of manufacturing a solid electrolytic capacitor according to claim 1, wherein
in said step of heating said solution, a heating temperature of said solution is lower than 100° C.
